(19) United States
(12) Patent Application Publication
(10) Pub. No.: US 2015/0258761 A1
(43) Pub. Date: Sep. 17, 2015

(54) MOISTURE RESISTANT WOODEN DOORS AND METHODS OF MANUFACTURING THE SAME

(71) Applicant: Simpson Door Company, Tacoma, WA (US)

(72) Inventors: Thomas M. Thompson, Montesano, WA (US); Steve D. Beerbower, McCleary, WA (US); George Meyer, McCleary, WA (US)

(21) Appl. No.: 14/664,634

(22) Filed: Mar. 20, 2015

Related U.S. Application Data
(62) Division of application No. 10/932,843, filed on Sep. 1, 2004, now abandoned.

(51) Int. Cl. B32B 37/14; B32B 37/10; B32B 37/18; B32B 37/02

(52) U.S. Cl. CPC B32B 37/144; B32B 37/02; B32B 37/10; B32B 37/18; B32B 2307/7265; B32B 2317/16; B32B 2419/00; B32B 2435/00

(57) ABSTRACT

The present disclosure relates to a weather resistant wooden door and methods for manufacturing and assembling the weather resistant wooden door. The weather resistant wooden door includes at least two stiles, a bottom rail, and a top rail configured to form the door assembly. A moisture resistant overlay is attached to either the aforementioned door components before assembly into a door or to the door assembly itself. The overlay is bonded to the underlying member by placing the overlay and member into a press where the pressure in the press is elevated for a predetermined amount of time. The overlay inhibits the infiltration of moisture from the environment.

### BACKGROUND OF THE INVENTION

1. Field of the Invention

The present description generally relates to wooden doors designed to resist moisture and methods of manufacturing the same.

2. Description of the Related Art

Exterior doors are often used as an architectural feature in a home, business, or other building. In many applications, architects request wooden exterior doors to impart a high quality, sophisticated appearance to a structure. Wood doors, for example, can be stained to use the natural wood grain in the exterior design of a structure. The exterior doors can be of various styles such as French doors. The exterior doors can also be located in different areas of a home, for example front entry doors, patio doors, or side garage doors.

Exterior wooden doors are often assembled from various frame module components that may include left and right wood stiles, top, lock and bottom wood rails extending between the stiles, and wood mullions extending between the rails to separate the wood panels. Wood panels or glazing components can be used to fill the openings between the frame module components. These doors may also utilize engineered components that include a veneer on one or more surfaces.

Although exterior wooden doors are often architecturally desirable, architects, builders, or owners often select metal and fiberglass doors because exterior wooden doors can experience moisture damage if they are not properly treated before installation and not properly maintained thereafter. For example, exterior wooden doors can absorb moisture in the open-grain ends of the stiles at the bottom of the door, moisture can travel up the joint between the bottom rail and stile modules, and moisture can also infiltrate through the surface of the wood over time. In either situation, the moisture is eventually wicked into the joint locations.

Because moisture cannot readily escape from the joint locations, rotting can occur in the lower and upper ends of a door, but most commonly in the lower end of the door. The moisture in the wood can further cause the rails and the stiles to warp or swell, which results in the door not maintaining a proper fit within the door frame, the deterioration of the appearance of the door, or both.

### BRIEF SUMMARY OF THE INVENTION

In one aspect of the invention, a moisture resistant wooden door includes a number of door components joined together to form the door; and a moisture resistant overlay bonded to at least one surface of the door for inhibiting the infiltration of moisture into the one surface of the door covered by the overlay, the overlay substantially covering the one surface.

In another aspect of the invention, a method of constructing a moisture resistant wooden door includes assembling a number of door components into a door assembly; adhering a moisture resistant overlay to at least one surface of the door assembly; inserting the door assembly with the overlay into a press; applying at least a pressure to the door assembly and the overlay; and removing the door assembly from the press.

In yet another aspect of the invention, a method of constructing a moisture resistant wooden door component includes obtaining at least one assembly-ready door component; adhering a moisture resistant overlay to at least one surface of the door component; inserting the door component with the overlay into a press; applying at least a pressure to the door component and the overlay; and removing the door component from the press.

### BRIEF DESCRIPTION OF THE SEVERAL VIEWS OF THE DRAWINGS

In the drawings, identical reference numbers identify similar elements or acts. The size and relative positions of elements in the drawings are not necessarily drawn to scale. For example, the shapes of various elements are not drawn to scale, and some of these elements are arbitrarily enlarged and positioned to improve drawing legibility. Further, the particular shapes and the elements are not intended to convey any information regarding the actual shape of the particular elements, and have been solely selected for their ease and recognition in the drawings.

FIG. 1 is an exploded front, left isometric view of a build-up door assembly and moisture resistant overlay according to one embodiment of the invention.

FIG. 2 is an exploded, front, left isometric view of door components having an overlay adhered to one surface according to another embodiment of the invention.

FIG. 3 is a flow diagram of a method for assembling a moisture resistant wooden door according to one embodiment of the invention.

FIG. 4 is an exploded, front, left isometric view of door components having corresponding overlays according to another embodiment of the invention.

FIG. 5 is a flow diagram of a method of assembling a moisture resistant wooden door component according to another embodiment of the invention.

FIG. 6 is a front elevational view of a moisture resistant wooden door in accordance with one embodiment of the invention.

FIG. 7 is an exploded, front, left isometric view of the component parts making up a stile according to one embodiment of the invention.

FIG. 8 is a front, right, isometric view of the stile of FIG. 7.

FIG. 9 is an exploded front, left isometric view of the component parts making up a rail according to one embodiment of the invention.

FIG. 10 is a front, left isometric view of the rail of FIG. 9.

### DETAILED DESCRIPTION OF THE INVENTION

The following description is generally directed toward exterior wooden doors and methods for fabricating exterior wooden doors. In all of the embodiments discussed below, a moisture resistant overlay can be adhered to a completed door assembly, or to each individual door component before assembly. The purpose of the overlay is to inhibit or resist moisture from penetrating the exterior surface of the door assembly. In some embodiments, assembling the door with moisture resistant end-caps, also referred to as performance blocks, and then applying the overlay can further augment the moisture inhibiting characteristics of an assembled door. Each of these features and variations thereof are discussed in detail below.

The description commences with a discussion of wooden door assemblies having a moisture resistant overlay and then follows with a discussion regarding methods of installing the overlay on a variety of door assemblies. The description closes with a general discussion on the various ways to assemble a wooden door. One skilled in the art, however, will understand that the invention may have additional embodiments, or that the invention may be practiced without several of the details described in the following description.

### Wooden Door Assemblies Having a Moisture Resistant Overlay Material

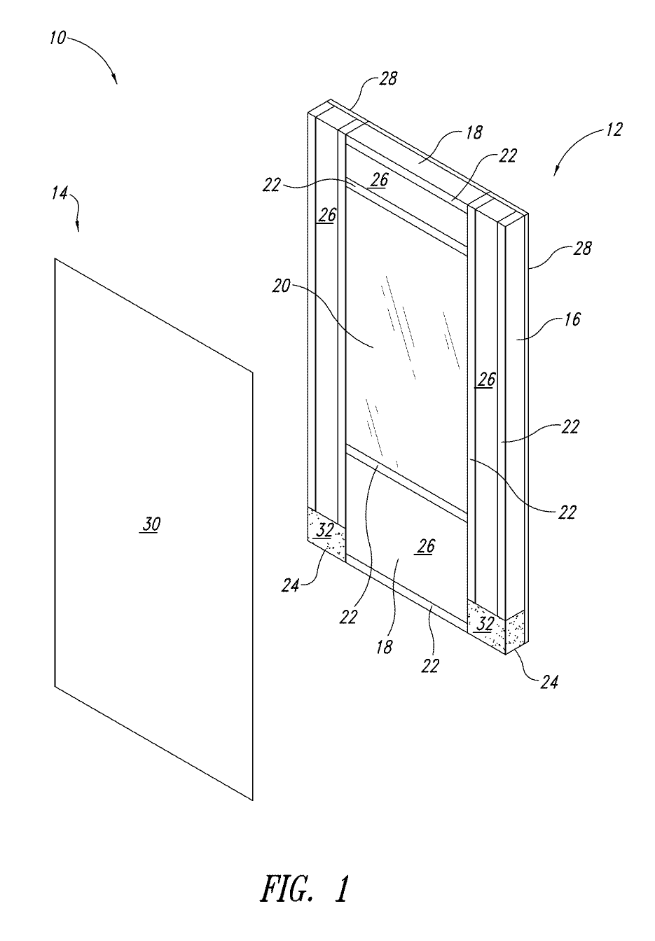

FIG. 1 is an exploded, isometric view of a wooden door 10 where the door includes a built-up wooden door assembly 12 and a moisture resistant overlay 14 according to one embodiment of the invention. The built-up wooden door assembly 12 includes stiles 16, rails 18, and a glazing 20. The glazing 20 is an industry term that refers to a glass insert used in a door 10. For purposes of clarity, the manufacture and construction of the stile modules 16 and rail modules 18 and details on the various methods of assembling built-up doors 12 are described in more detail below. As shown in the illustrated embodiment, the door assembly 12 has both stile modules 16 and rail modules 18, each bounded by edge strips 22. In addition, the illustrated door assembly 12 has performance block members 24, a first exterior surface 26, and a veneer 28 attached to the interior surface (not shown). When the overlay 14 is attached to the built-up door assembly 12, overlay 14 covers and is coextensive with the first exterior surface 26, such that an exterior surface 30 of the overlay 14 becomes the exterior surface of the finished door. The overlay 14, after attachment to the built-up door assembly 12, provides the door 10 with a smooth and seamless appearance.

The overlay 14 is made from a material that can be primed, painted, and resists the infiltration of moisture through the thickness of the overlay 14. Overlay 14 may also be pre-primed. One type of overlay material found to have good moisture resistant characteristics is made from a phenolic resin-impregnated paper having a thickness in the range of 0.010 inches to 0.040 inches, with an average or typical thickness of 0.020 inches. The industry name for this type of overlay is Medium Density Overlay (MDO). In addition to the moisture resistant properties of the overlay 14, other attributes of the overlay 14 are that it masks imperfections in the door 10 and if pre-primed, the overlay 14 may be painted without any preparation. Moreover, the overlay 14 can be easily and cleanly machined, for instance when making the cutout in the overlay 14 to display the glazing 20. It will be understood that the overlay 14 may be a solid sheet, for example when used on a door that does not contain a glazing component.

As an alternative to the phenolic resin-impregnated paper—MDOs, the overlay 14 can be made from vinyl or laminate material comprised of melamine, phenolic plastic, polyester, or other thermosetting plastic. Overlay 14 material is typically produced in extruded sheet form, for example similar to vinyl, or in rolls. The overlay can be opaque or transparent. The overlay 14 can also be pre-coated with a chemical activated or heat activated adhesive, as this would eliminate the need to use a separate adhesive to attach the overlay 14 to the door assembly 12. Using a pre-coated overlay 14 provides the manufacturer the advantage of not having to store adhesive in inventory, which can reduce the cost of the finished product. One manufacturer of overlays 14 is a Finland based company called Dynea Overlays with a manufacturing plant in Tacoma, Wash.

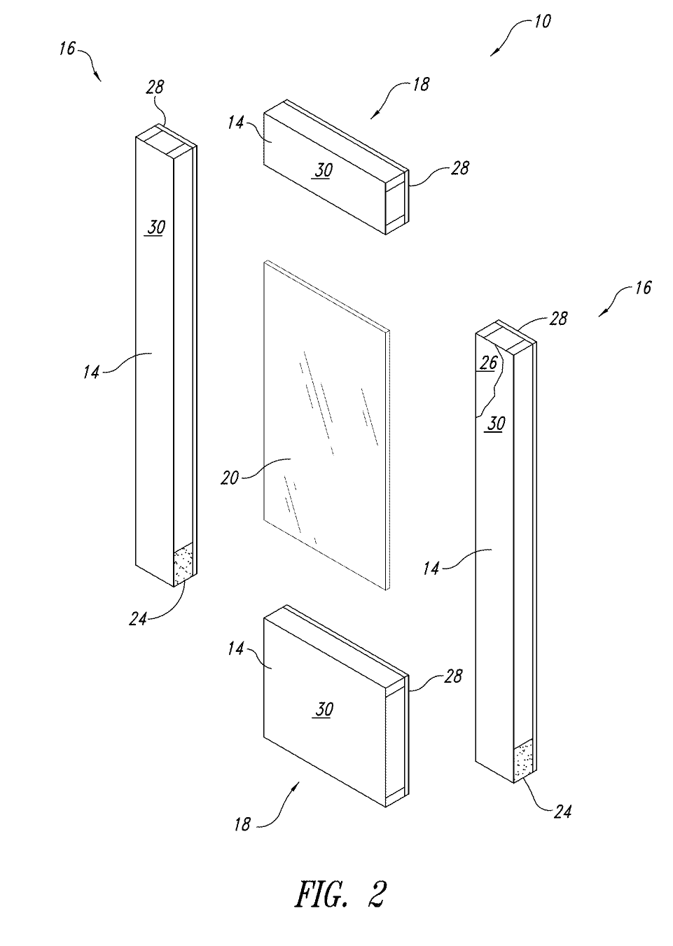

FIG. 2 illustrates another embodiment of the present invention where the overlay 14 is affixed to each of the individual, wood door components 16 and 18 before these components are assembled to form the door 10. Although the door modules are joined and aligned using part profiles and dowel pins, these features are not shown in the illustrated embodiment for purposes of clarity. Affixing the overlay 14 in the described manner results in the exterior surface 30 of the door 10 having visible seams at the locations where the stile modules 16 and the rail modules 18 are joined. The methods of affixing the overlay 14 to the component parts 16 and 18 are essentially the same as the methods for affixing the overlay 14 to the built-up door assembly 12. The prominent difference, as discussed in more detail below, is that a smaller press can be used to affix the overlay 14 to the component parts 16 and 18.

Methods of Attaching Overlay Material onto Wooden Door Components

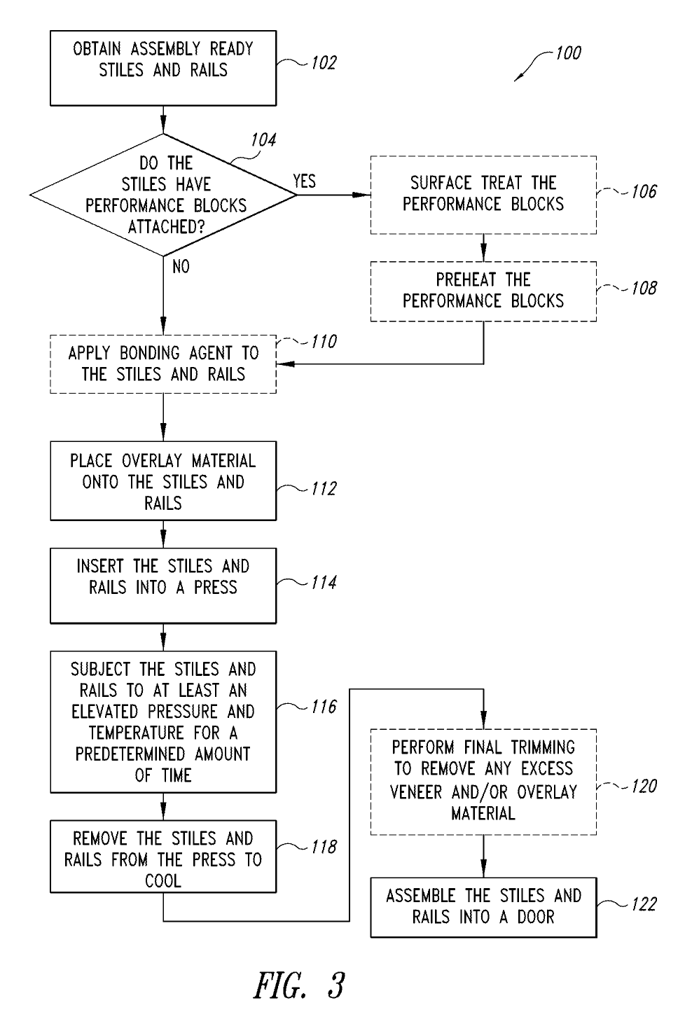

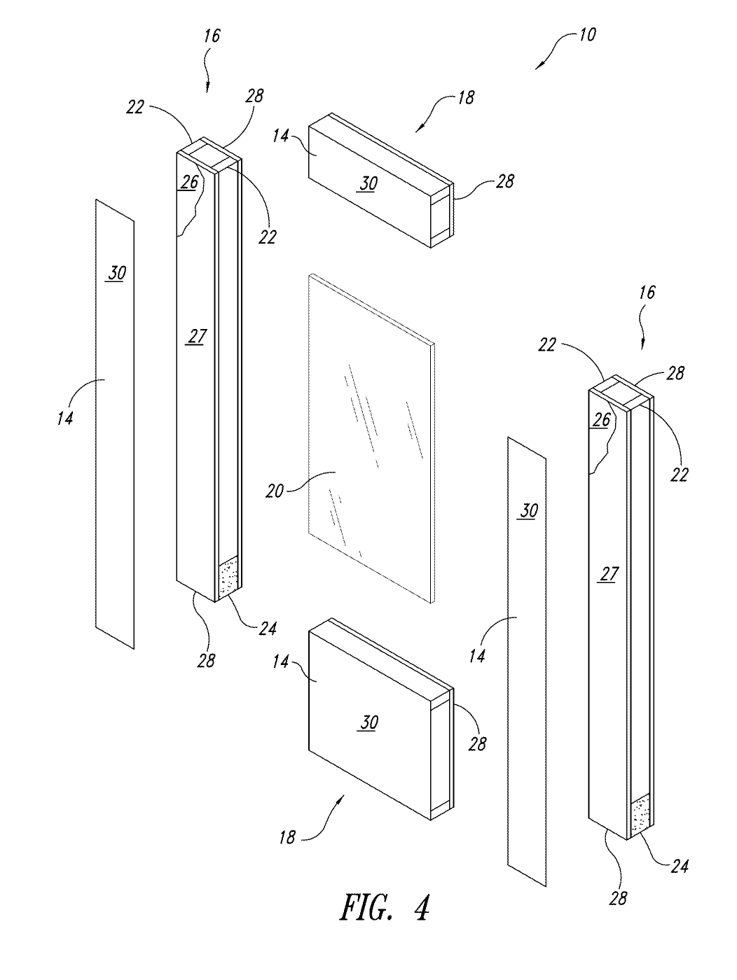

FIG. 3 is a flow diagram illustrating one method 100 for assembling a built-up door assembly 12 with an overlay 14. The first step 102 of the illustrated method involves obtaining assembly ready stile modules 16 and assembly ready rail modules 18. The distinction between an assembly ready stile module 16 and raw stock components are discussed in more detail below. The assembly ready stile modules 16 and assembly ready rail modules 18 are typically stocked with part numbers in inventory. The assembly ready stile modules 16 can be built up from raw stock components that may include edge strips 22, a performance block 24, and veneer 28. Likewise, the assembly ready rail module 18 can be built up from raw stock components that may include edge strips 22 and a veneer 28. In one embodiment, both the stile module 16 and the rail module 18 can have veneer 28 attached to both sides as part of the build-up process (FIG. 4).

In the illustrated method, a determination is made as to whether the stile modules 16 include performance blocks 24, step 104. If performance blocks 24 are attached to the stile modules 16, then extra steps must be performed in order to insure that the overlay 14 properly bonds with the built-up door assembly 12. More particularly, if performance blocks 24 are used, the performance blocks 24 are surface treated and preheated, steps 106 and 108 respectively.

Surface treating the performance blocks 24 is done to create a more secure bond between the performance block 24 and the overlay 14. One treatment method is to sand the receiving surface 32 (FIG. 1) of the performance block 24 to which the overlay 14 will be bonded. A somewhat coarse sand paper, for example 50-80 grit sand paper, has been found to sufficiently roughen the receiving surface 32 and thus establish a sufficient bonding surface. However, one skilled in the art will appreciate and understand that a variety of surface roughening methods as well as different grades of sand paper can be used to improve the bonding surface of the performance block 24.

Preheating the performance blocks 24, in step 108, has been found to further enhance the bond between the performance blocks 24 and the overlay 14. One method of preheating the performance blocks 24 is to blow hot air onto the performance blocks 24 to raise the temperature of the performance blocks 24 to a point where they are hot to the touch. An adequate temperature for the performance blocks 24 prior to applying the bonding agent has been found to be in the range of 140 degrees Fahrenheit to 180 degrees Fahrenheit, with a preferred range of about 160 degrees Fahrenheit to 170 degrees Fahrenheit.

However, if the exterior surface of the stile module 16 has received a raw stock veneer component 28, then the steps to prepare the surface of the performance block 24 for bonding can be eliminated.

To attach the overlay 14 to the stile module 16 or rail module 18, a bonding agent is applied to at least one face of the respective stile module 16 or rail module 18, step 110. The receiving face 26 that receives the bonding agent can be either a veneered surface or a non-veneered surface, depending on how the component 16 or 18 was built up. Referring back to FIG. 2, the component parts 16 and 18 do not have any veneer 28 attached to their exterior side 26, thus their exterior side 26 is also the receiving surface 26 for the bonding agent and thus the overlay 14. In contrast, FIG. 4 illustrates the component parts 16 and 18 with veneer 28 attached to the parts' exterior side 26. The exterior surface 27 of the attached veneer 28 becomes the receiving surface 27 for the bonding agent and thus the overlay 14. Alternatively and as discussed above, the overlay 14 can be pre-coated with a glue line adhesive, which makes step 110 unnecessary. If the overlay with the glue line is used, the exterior surface of the stile module has to include a raw stock veneer component 28.

The bonding agent may be an adhesive such as polyvinyl acetate (PVA) or some other suitable adhesive. PVA adhesive is a curing adhesive that can be applied by rollers, wheels, extruders, ball pen applicators or a spray system. The rate of development of the bond strength will depend upon ambient temperature, applied pressure, substrate type, porosity and moisture content. In step 112, the overlay 14 is placed onto the receiving surface of the component that was wetted with the bonding agent. The component parts are then placed into a press, step 114, and subjected to an elevated pressure and temperature, step 116.

In one embodiment, the pressure in the press is set within the range of about 100-200 pounds per square inch (psi), the temperature within the press is elevated to be within the range of about 200-300 degrees Fahrenheit, and the modules 16 and 18 are treated in the press for about two to four minutes. In an alternate embodiment, the pressure in the press is set within the range of about 100-200 psi, the temperature within the press is maintained at ambient or room temperature, and the modules 16 and 18 are treated in the press for about 25-35 minutes.

After the overlay 14 has been in the press for the preselected amount of time, the components are removed from the press in order to cool, step 118. Any final trimming, machining, or sanding operations, if needed, for example routing the overlay material around the edges, can then be performed, step 120. Finally, in step 122, the stile module 16 and the rail module 18 are assembled into a moisture resistant wooden door 10, which may or may not include a glazing 20. Bonding the modules 16 and 18 is accomplished by applying adhesive to the dowel holes, the sticking, and the faces of the joining surfaces of the modules 16 and 18.

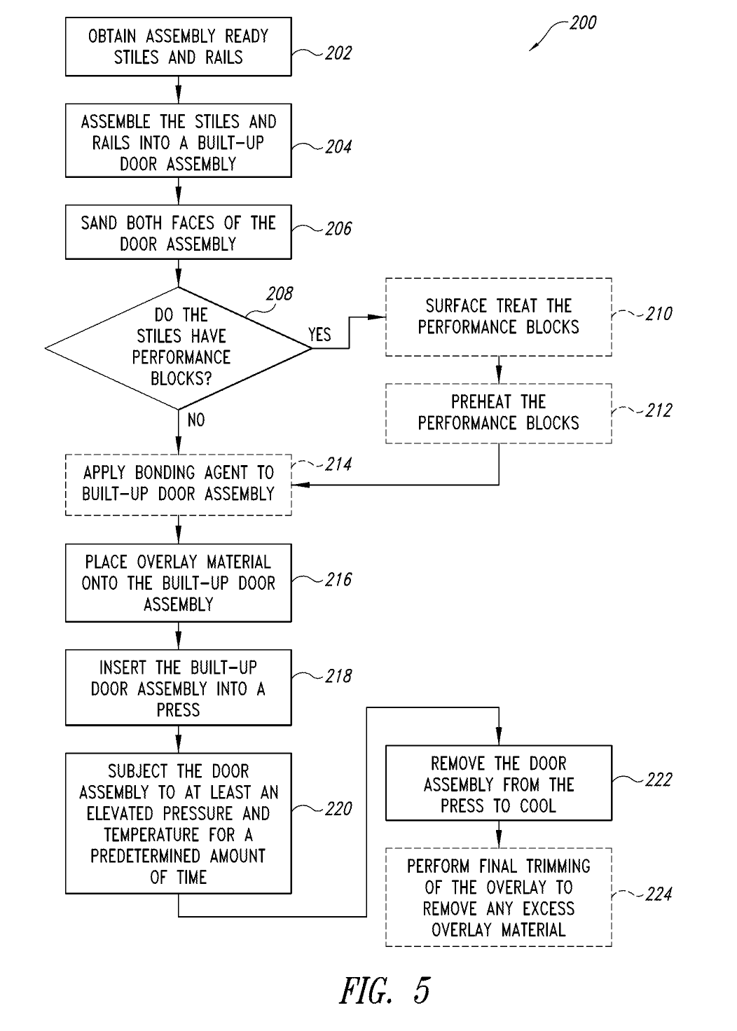

FIG. 5 is a flow diagram illustrating another method 200 for assembling a moisture resistant door 10 with an overlay 14. The present method mimics the operations of the previous embodiment, except that the stile modules 16 and rail modules 18 are assembled into a built-up wooden door assembly 12 before the overlay 14 is attached.

The first step 202 of the illustrated method 200 involves obtaining assembly ready stile modules 16 and assembly ready rail modules 18. In step 204, the stile modules 16 and rail modules 18 are assembled into a build-up door assembly 12. In step 206, the built-up door assembly 12 is sanded to bring the outside surface within the flatness tolerance and remove any imperfections. In one embodiment, 50 grit paper can be used to initially sand the door surfaces, while 80-100 grit paper can be used to finish-sand the door surfaces.

Steps 208 through 212 are the same as the corresponding steps discussed in the previous method 100. In optional step 214, a bonding agent is applied to the receiving surface of the built-up door assembly 12. The receiving surface can be either a veneered surface or a non-veneered surface, as discussed above. The bonding agent may be an adhesive such as polyvinyl acetate (PVA) or some other suitable adhesive. Alternatively, the overlay 14 may be pre-coated with a glue line adhesive, thus making step 214 unnecessary. If the overlay 14 with the glue line is used, the exterior surface of the stile module 16 has to include a raw stock veneer component 28. In step 216, the overlay is placed onto the receiving surface of the built-up door assembly 12.

Steps 218 through 224 are substantially similar to the corresponding steps of the previous embodiment, except in the present embodiment, the door 10 is inserted into the press in step 218. The time, pressure, and temperature applications discussed in the previous embodiment are equally applicable here. In step 222, the door 10 is removed from the press to cool. Finally, in step 224, any final trimming or machining can be done to the overlay 14, the door 10, or both. For example, even if the door includes a glazing 20, the overlay 14 may be attached to the built-up door assembly 12 as a full sheet, thus covering the glazing 20. Therefore, after the door 10 is removed from the press, the overlay 14 must be trimmed to expose the glazing 20. The trimming of the overlay 14 is typically done with a router.

In another embodiment, a hot roll laminating system uses a heat application to bond the overlay to the wooden door. The overlay and door are simultaneously fed through a series of pinch rollers that apply heat and pressure to the door surface. The heat activates the adhesive on the backside of the overlay, which creates a bond to the outer surface of the door.

### Wooden Door Assemblies—Generally

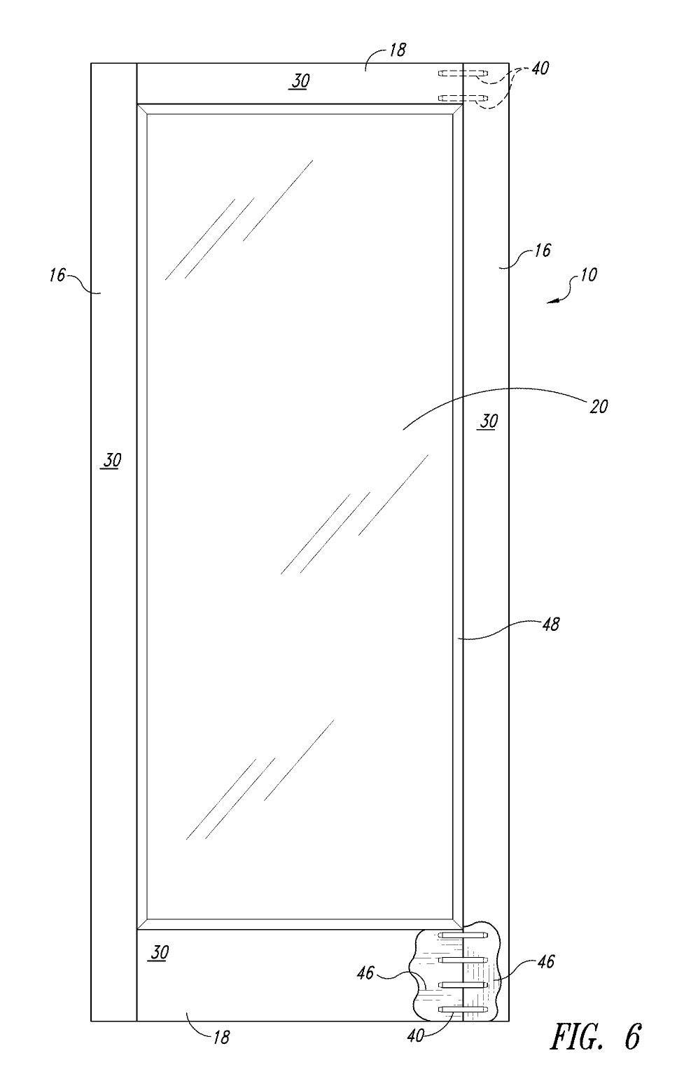

FIG. 6 is a front elevational view of a wooden door assembly 10 according to one embodiment of the invention. The purpose of FIG. 6 is to illustrate the primary components that are used to assemble a typical French style wooden door 10. The primary components of the assembly 10 are the stile modules 16, the rail modules 18, an optional glazing 20, and dowels 40 for securing the door components together. The basic construction of the stile modules 16 and rail modules 18 in preparation for assembly into the door 10 is described in more detail below. The discussion begins by following the construction of the stiles 16 and rails 18 as they would come from the raw material lumber supplier, and be subsequently built up into engineered, assembly-ready door components. In the illustrated embodiment, performance blocks 24 (FIG. 4) are not shown. One skilled in the art will understand and appreciate that the illustrated door 10 of FIG. 6 can include performance blocks 24, but they are not necessary.

### Stile Construction—Generally

The stile modules 16 are the structural side supports for the door 10. The stile modules 16 are typically made from wood species such as Pine, Fir, or Hemlock, although other types of wood can be used. Additionally or alternatively, at least a portion of the stile modules 18 can be made from a composite material, such as the composite material used for the performance blocks described above, for example. Components for the stile modules 16 arrive at the door manufacturer as raw stock parts. A raw stock part is a wooden door component that has been cut to at least the approximate dimensions for assembly into a door 10. It is often the goal of the door manufacturer to receive the raw stock parts in such a configuration that no further machining is required, but due to variations in humidity, tooling, etc., it can be necessary that the raw stock parts need to be machined upon arrival at the door manufacture in order to make the raw stock parts ready for the build up process.

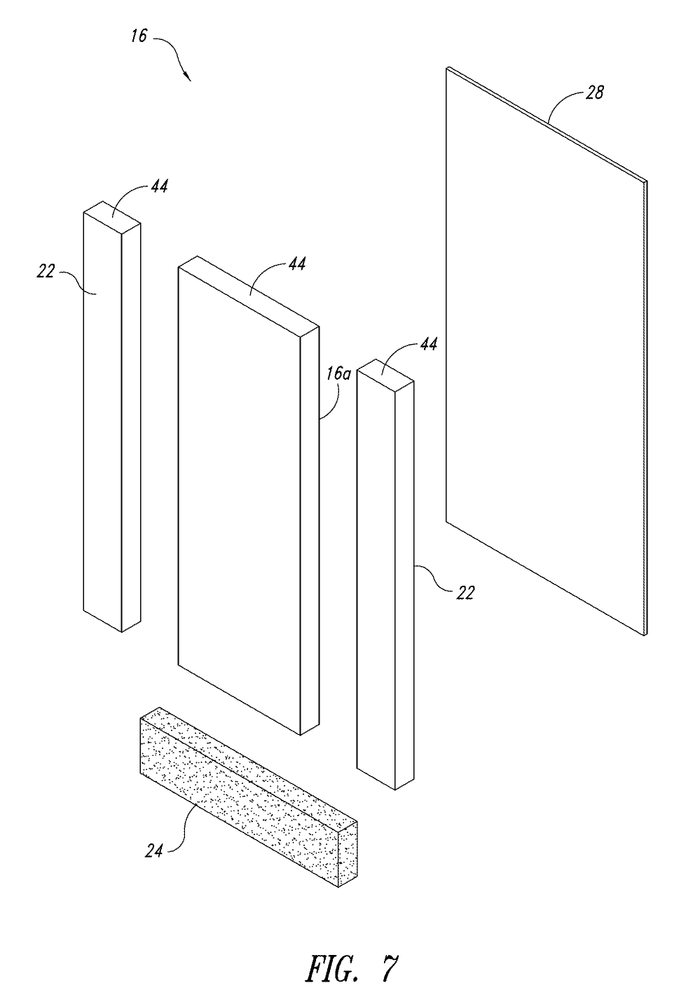

FIG. 7 illustrates an exploded isometric view of several raw stock parts, a stile core 16a, veneer 28, edge strips 22, and a performance block 24, about to be assembled into an assembly-ready, engineered door component, which is referred to as a stile module 16 according to one embodiment of the invention.

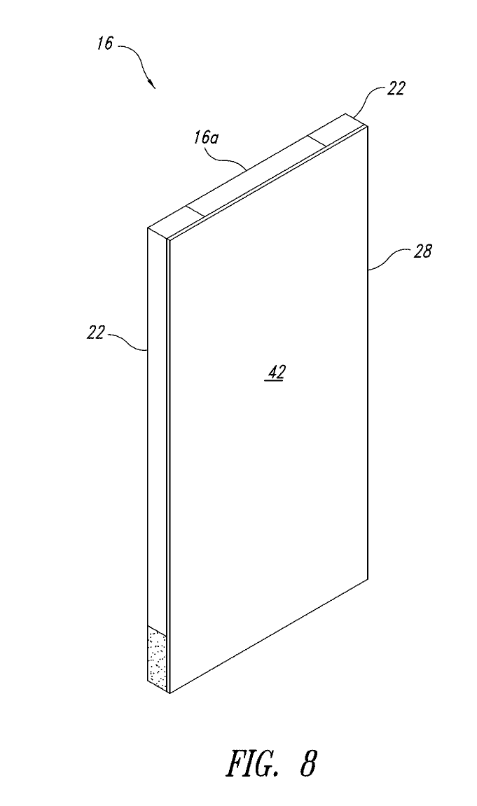

FIG. 8 illustrates a stile module 16 assembled with the components identified above. The edge strips 22 are usually made from higher quality wood. The addition of edge strips 22 and the type of wood used for the edge strips 22 are often left to a customer's preference because the edge strips 22 are visible in the assembled door 10 and therefore must be capable of accepting certain types of stain or matching a customer's existing décor. Depending on the configuration of the door 10, for example whether the door is solid wood or contains a glazing 20 (FIG. 1), the stile module 16 can have no edge strips, one edge strip, or two edge strips. The wood species selected for the edge strips 22, however, is typically, but not necessarily, selected from the same wood species from which the veneer 28 is made, or vice-versa

Once the cut blank details are joined together, the top and bottom surfaces of the built-up components are then planed to make them flat and parallel. Veneer 28 can then be adhered to at least one surface with a bonding agent such as polyvinyl acetate (PVA) or other suitable adhesive. In the illustrated embodiment, the veneer 28 is applied to only the interior surface 42 of the assembled raw stock components.

Referring back to FIG. 6 briefly, the raw stock components, excluding the performance block 24, can have an exposed end grain 44. The exposed end grain 44 occurs on both the upper and lower edges of the various parts. Of particular significance is the exposed end grain 44 on the lower edge of the stile core 16a and the edge strips 22. One common way for an exterior wooden door 10 to experience moisture damage is when water infiltrates through the end grain 44 of the stile core16a. The water eventually works into the dowel pinholes found in the stile modules 16 and the rail modules 18 and deteriorates the raw stock components of the rail module 18 over time. The resulting damage can be swelling of the door due to the increased moisture content, loosened joints, wood rotting, and a number of other phenomena.

In order to avoid water infiltration through the end grains 44 of the stile core 16a and/or edge strips 22, one embodiment of the present invention incorporates the performance block 24 to protect the end grain 44 regions the stile module 16. Details regarding the various alternatives for performance blocks 24 are discussed below.

Referring back to FIGS. 7 and 8, the performance block 24 can be an extruded block or strip of a composite material. The composite material, in turn, is a polymeric matrix impregnated with small wood particles (e.g., a wood flour). The polymeric material, for example, can be a polyethylene or a polyolefin. One suitable wood/polymer composite includes approximately 30%-60% wood particles by weight and approximately 40%-70% polymeric material by weight. The performance block 24 can also be composed of other materials that have low moisture absorption or complete moisture resistant characteristics, expansion and contraction characteristics similar to wood, and can be glued to wood, painted, stained and/or machined. Suitable extruded wood/polymeric composites are manufactured by Crane Plastics Co. of Columbus, Ohio under their TimberTech™ product line. The performance block 24, for example, can also be a block or strip of another type of moisture resistant material, such as a polymeric material without wood. Alternatively, the performance block 24 can be made from treated or impregnated wood where the wooden block is treated or impregnated to make it sufficiently impenetrable to moisture and/or wicking.

The various styles of performance blocks 24, methods of attaching the performance blocks 24, and other purposes and advantages of the performance blocks 24 are described in detail in the following U.S. patent: “WOOD DOORS AND METHODS FOR FABRICATING WOOD DOORS” U.S. Pat. No. 6,185,894 issued to Sisco et al, filed on Jan. 14, 1999.

### Rail Construction—Generally

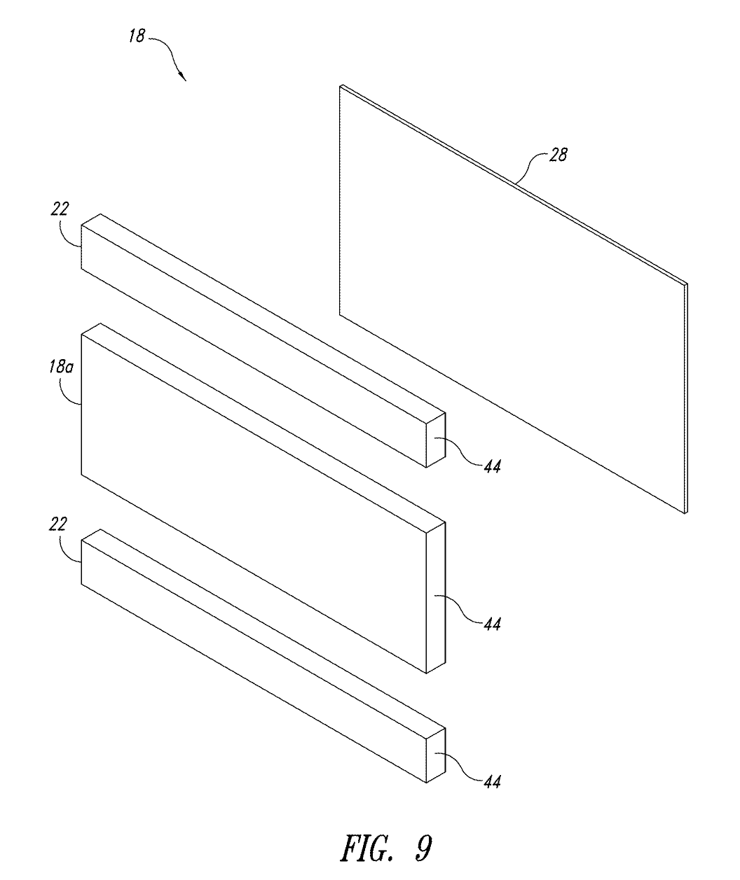

FIG. 9 illustrates a rail module 18 used in the construction of a door 10. The rail modules 18 are the upper and lower supports for the door 10. The construction of the rail modules 18 is very similar to the construction of the stile modules 16, discussed above. The industry term for an assembly-ready, engineered rail 18 is a rail module 18. The rail modules 18 are typically made from wood species such as Pine, Fir, or Hemlock, although other types of wood can be used. Additionally or alternatively, at least the entire bottom rail module 18 can be made from a composite material, such as the composite material used for the performance blocks described above, for example. Like the stiles module 16, the components of the rail module 18 typically arrive at the door manufacturer as raw stock parts.

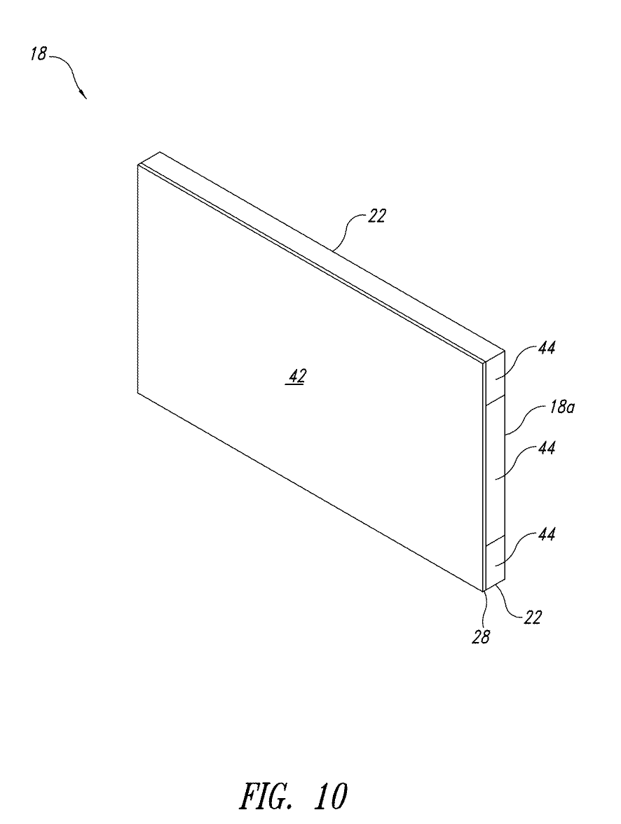

In the illustrated embodiment of FIG. 10, the rail module 18 is comprised of a raw stock rail core 18a, veneer 28, and edge strips 22. The method of assembling the rail module 18 does not different to any significant degree with respect to the method of assembling the stile module16 as discussed above. Similarly, the edge strips 22 are usually made from higher quality wood and subject to the customer's preferences. The rail module 18 can have no edge strips, one edge strip, or two edge strips. The wood species selected for the edge strips 22, is typically, but not necessarily, selected from the same wood species from which the veneer 28 is made, or vice-versa.

The rail core 18a and the edge strips 22 are joined together. The top and bottom surfaces of the assembly are then planed to make them flat and parallel. The veneer 28 can then be adhered to at least one surface with a bonding agent such as (PVA) or other suitable adhesive.

As illustrated, the various raw stock components can have an end grain 44. However, unlike the stile core 16a, the end grains 44 of the respective rail core 18a and edge strips 22 are not exposed because the end grain 44 surfaces are abutted with the stile module 16 during the door assembly. However, one area of concern with respect to water infiltration into the rail module 18 is that the exposed surfaces of the rail module 18 can absorb moisture through longitudinal interstices 46 (FIG. 6; lower right hand corner of door) in the exposed regions of the rail module 18 and through the joints between the rail module 18 and stile module 16 in the built-up door assembly 12. The surfaces of the stile module 16 are also susceptible to moisture infiltration. However, with the application of the overlay 14 onto either the door components or the built-up door assembly 12, the problem of moisture infiltration into the longitudinal interstices 46 is greatly reduced or even eliminated.

Referring back to FIG. 1 (lower right hand corner of the door), the dowels 40 are inserted into complementary holes to attach the stile module 16 and the rail module 18 with adhesive to securely bond the components together. One type of adhesive that can be used for joining the door components together is a Polyurethane Reactive Hotmelt (PUR) which is a moisture curing adhesive designed to adhere wood, metal, laminates, rubber, some plastics and many other substrates. On curing, carbon dioxide is released which causes the PUR adhesive to swell slightly. The PUR adhesive is non-flammable and the cured PUR adhesive has a good degree of flexibility. The assembly of a door according to at least one embodiment of the invention is described in detail in U.S. patent: “WOOD DOORS AND METHODS FOR FABRICATING WOOD DOORS” U.S. Pat. No. 6,185,894 issued to Sisco et al, filed on Jan. 14, 1999.

As previously mentioned, the center portion of the door 10 can be a glazing 20, which is typically a glass insert, but can be any variety of aesthetic materials that would enhance the appearance of the door and/or allow light to be transmitted therethrough. The glazing 20 is typically affixed within the door assembly 10 with a sticking and glazing bead 48 (FIG. 6). The sticking is a profile machined into the edges of the stile module 16 and the rail module 18 to accept the inserted glazing 20. The glazing bead 48 is generally a small wood molding applied to the perimeter of the glazed opening to secure the glazing 20 with the door 10.

The descriptions provided herein where an overlay 14 is applied to a wooden door assembly, illustrate that the overlay 14 may be applied to various embodiments of a door assembly and provide numerous advantages. The overlay 14 can inhibit or prevent moisture damage, yet provide an aesthetically pleasing, smooth, door surface. In addition, application of the overlay 14 to a wooden door minimizes the amount of maintenance required, for example re-staining or re-painting.

In the above description, certain specific details are set forth in order to provide a thorough understanding of various embodiments of the invention. However, one of ordinary skill in the art will understand that the invention may be practiced without these details. The U.S. patent referred to in this specification, U.S. patent: “WOOD DOORS AND METHODS FOR FABRICATING WOOD DOORS” U.S. Pat. No. 6,185,894 issued to Sisco et al and filed on Jan. 14, 1999, is incorporated herein by reference, in its entirety.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Any headings provided herein are for convenience only and do not interpret the scope or meaning of the claimed invention.

One reasonably skilled in the art will understand that particular features of the various embodiments may be combined with other embodiments to create new embodiments. These and other changes can be made to the invention in light of the above detailed description. In general, in the following claims, the terms used should not be construed to limit the invention to specific embodiments disclosed in the specification, but should be construed in accordance with the claims. Accordingly, the invention is not limited by the disclosure, but instead its scope is to be determined entirely by the following claims.

We claim:

1. A method of constructing a moisture resistant wooden door, comprising:
assembling a plurality of door components into a door assembly;
adhering a moisture resistant overlay to at least one surface of the door assembly;
inserting the door assembly with the overlay into a press;
applying at least a pressure to the door assembly and the overlay; and
removing the door assembly from the press.
